(19) United States
(12) Patent Application Publication
(10) Pub. No.: US 2005/0044528 A1
(43) Pub. Date: Feb. 24, 2005

(54) Systems and methods for viewing code

(76) Inventor: Jesse Dale Olsen, San Diego, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/643,139

(22) Filed: Aug. 18, 2003

(51) Int. Cl. G06F 9/44

(52) U.S. Cl. 717/109

(57) ABSTRACT

Methods for viewing code are provided. An embodiment of a method comprises the steps of: identifying a procedure; providing a visual indicator corresponding to procedure content associated with the procedure; and displaying the procedure content in association with the procedure in response to an operator actuating the visual indicator. Systems and computer-readable media also are provided.

### BACKGROUND

When developing code, the code is typically displayed to an operator by use of a text editor application. The text editor application not only allows the code to be displayed to the operator via a display device, it enables the operator to make edits to the code on-screen.

An example of a text editor view of exemplary pseudo-code is depicted in FIG. 1A. In FIG. 1A, the procedure “myFunction” is invoked inside the “main” procedure. The text editor view reveals that a relationship exists between the procedure “myFunction” and “otherFunction.” However, little information about the specific implementation of the procedure “myFunction” is presented.

Likewise, little information about the specific implementation of a procedure is presented to an operator when debugging code. When debugging code, an operator typically uses a debugger that enables the operator to execute the code one line at a time. For example, each line of the code can be stepped “over” or “into.” Stepping over a line of code enables that line of code to be executed. Stepping into a line of code enables the operator to view function calls associated with that line of code. By stepping into functions, an operator can traverse several layers of the code. Because of this, a program counter typically is used to keep track of the next line of code that is to be executed. In a conventional debugger, an arrow often is used to point to the next line of code to execute.

FIG. 1B depicts an example of a call stack trace view that typically is used by an operator when debugging code. This view enables the operator to determine which functions have been stepped into. In this example, the procedure “otherFunction” was stepped into from the procedure “myFunction,” and “myFunction” was stepped into from “main.”

### SUMMARY

Systems and methods for viewing code are provided. An embodiment of a method comprises the steps of: identifying a procedure; providing a visual indicator corresponding to procedure content associated with the procedure; and displaying the procedure content in association with the procedure in response to an operator actuating the visual indicator.

An embodiment of a computer-readable medium has a computer program stored thereon for viewing code. In particular, the computer program is executable to perform the method steps of: receiving information corresponding to a procedure; displaying a visual indicator corresponding to procedure content being associated with the procedure; receiving information corresponding to an operator actuating the visual indicator; and displaying the procedure content in association with the procedure in response to the operator actuating the visual indicator.

An embodiment of a system for viewing code comprises a call tree code view system that is operative to: receive information corresponding to a procedure; display a visual indicator corresponding to procedure content being associated with the procedure; receive information corresponding to an operator actuating the visual indicator; and display the procedure content in association with the procedure in response to the operator actuating the visual indicator.

Other systems, methods, features and/or advantages will be or may become apparent to one with skill in the art upon examination of the following drawings and detailed description. It is intended that all such additional systems, methods, features and/or advantages be included within this description and be protected by the accompanying claims.

### BRIEF DESCRIPTION OF THE DRAWINGS

The components in the drawings are not necessarily to scale relative to each other. Like reference numerals designate corresponding parts throughout the several views.

FIG. 1A a schematic diagram depicting information displayed by a prior art text editor.

FIG. 1B is a schematic diagram depicting information displayed by a prior art call stack trace view.

FIG. 2 is a schematic diagram depicting information displayed by an embodiment of a call tree code view system.

FIG. 3 is a schematic diagram depicting the information of FIG. 2, showing an operator actuating a visual indicator associated with a procedure.

FIG. 4 is a schematic diagram depicting information displayed to the operator in response to actuating the visual indicator of FIG. 3.

FIG. 5 is a schematic diagram depicting a computer or processor-based device that can be used to implement an embodiment of a call tree code view system.

FIG. 6 is a flowchart depicting functionality of the embodiment of the call tree code view system of FIG. 5.

FIG. 7 is a schematic diagram depicting information displayed to an operator in response to actuating multiple visual indicators associated with procedures.

FIG. 8 is a schematic diagram depicting information displayed to an operator when the content associated with a procedure is located in another file.

FIG. 9 is a flowchart depicting functionality of another embodiment of a call tree code view system.

FIG. 10 is a schematic diagram depicting information displayed to an operator by an embodiment of a call tree code view system.

FIG. 11 is a schematic diagram depicting information displayed to an operator using the call tree code view system of FIG. 10, with one of the functions being expanded to show associated procedure content.

### DETAILED DESCRIPTION

As will be described in detail here, systems and methods for viewing code can be used to provide an operator with an enhanced view of procedure implementations as compared to the prior art. Specifically, the systems and methods, such as the embodiments described below, can provide enhanced functionality compared to conventional systems that provide views of a call stack.

In this regard, some embodiments display the particular implementation (“procedure content”) of a procedure in association with the procedure. By way of example, the procedure content can be displayed in response to actuation of a visual indicator by the operator. The visual indicator can be the procedure name displayed in an underlined format, which appears much like a hyperlink associated with the Internet, for example. By clicking the underlined procedure name, the procedure content can be displayed in association with the procedure, such as in indented format between lines that follow the invoked procedure. In other embodiments, the visual indicator is a “+” or “−” that can be actuated to expand or collapse the procedure content.

Call tree code view systems will now be described for providing the functionality mentioned above. Specifically, information displayed by an embodiment of a call tree code view system is depicted schematically in FIG. 2. As shown in FIG. 2, the procedure “myFunction” is depicted in underlined format. Thus, the underlined text of “myFunction” serves as a visual indicator for informing an operator that procedure content associated with that procedure can be displayed. Note that the procedures “otherFunction” and “caller” also are underlined, indicating procedure content corresponding to these procedures also can be displayed in association therewith.

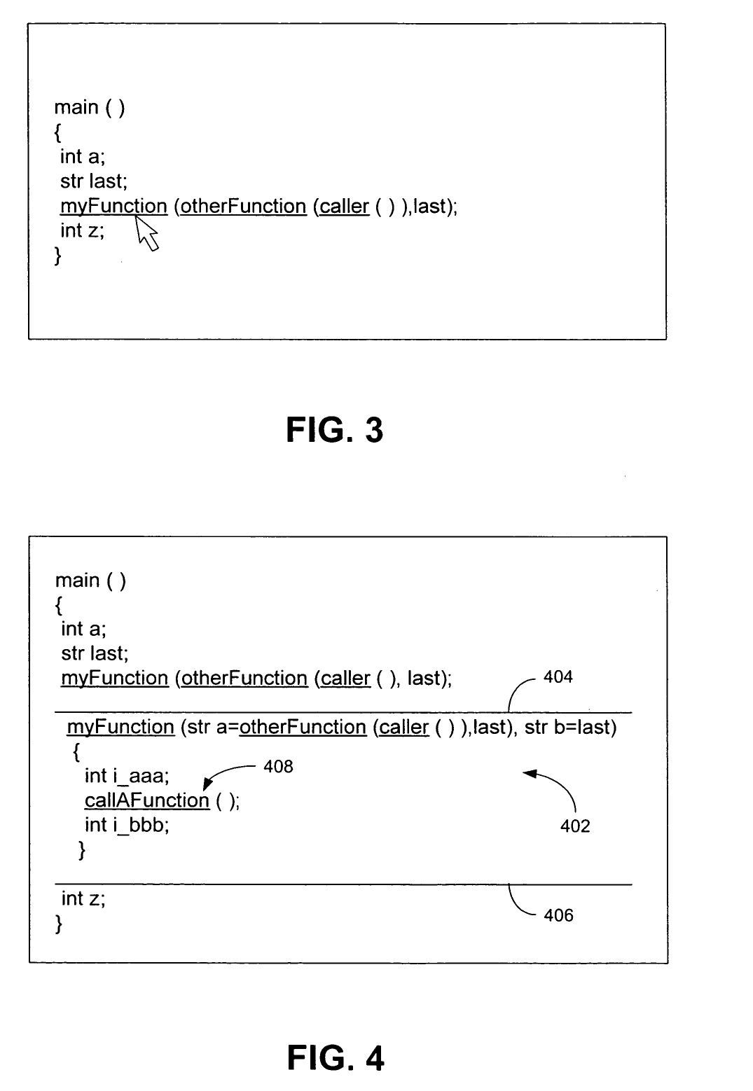

As shown in FIG. 3, an operator can actuate the “myFunction” visual indicator by clicking the underlined text. In response thereto, the procedure content associated with the “myFunction” procedure is displayed in association with the “myFunction” procedure. Specifically, in the embodiment depicted in FIG. 4, the “myFunction” procedure content is displayed between first and second lines that are spaced from each other. In particular, the procedure content 402 is displayed between lines 404 and 406. Note also that the procedure content is indented with respect to the invoked “myFunction” code. As well, the procedure content includes an additional procedure that is identified by a visual indicator, i.e., “callAFunction” is underlined. Thus, the user could view procedure content associated with the “callAFunction” procedure by actuating the visual indicator 408.

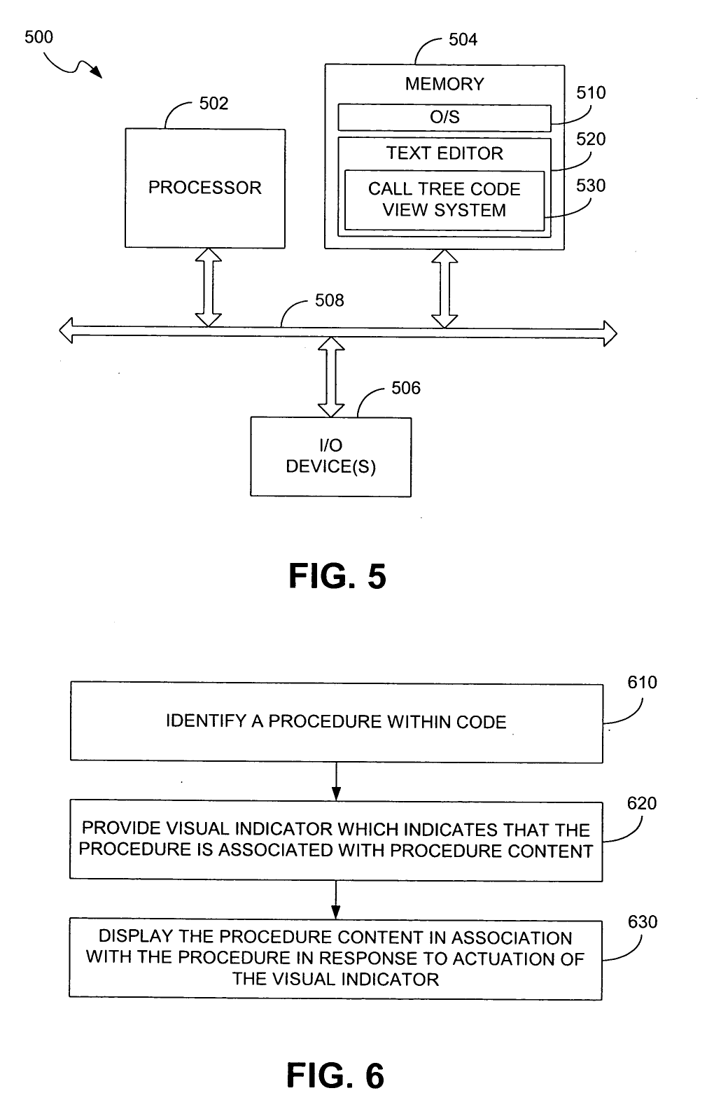

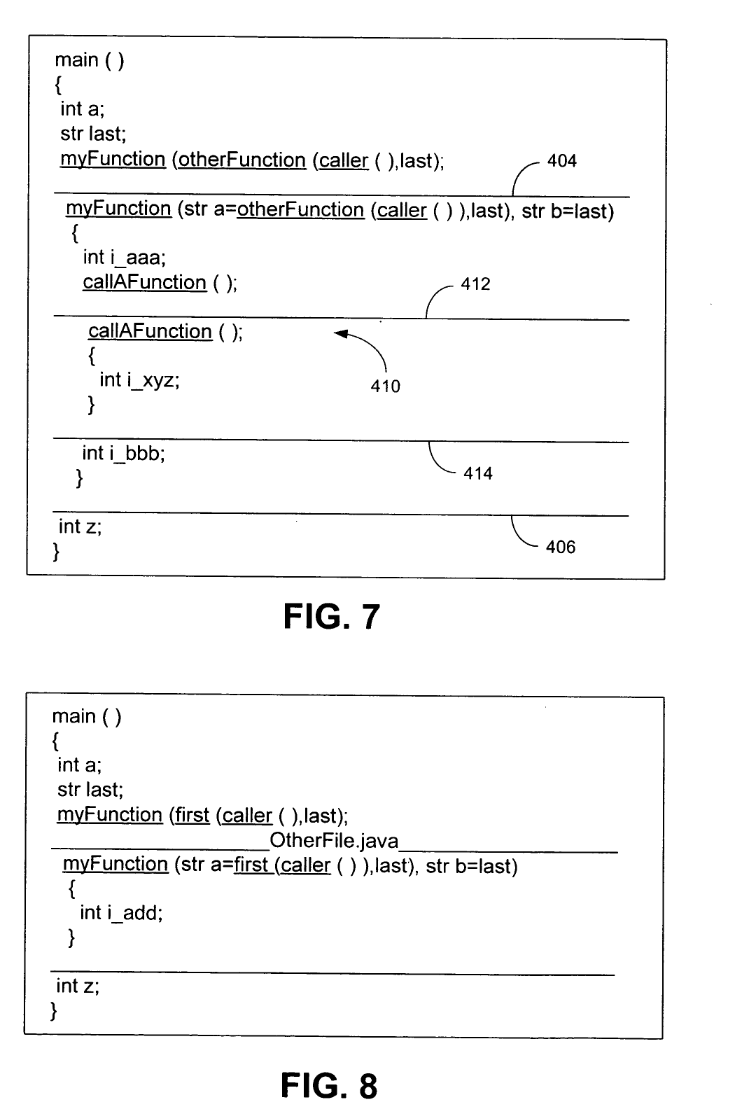

It should be noted that embodiments of call tree code systems can be implemented in hardware, software and/or combinations thereof. When implemented in software, a call tree code view system can be associated with a computer or processor-based device that executes instructions stored in the software. An example of a computer that can be used to implement an embodiment of a call tree code view system will now be described with respect to FIG. 5.

Generally, in terms of hardware architecture, computer 500 includes a processor 502, memory 504, and one or more input and/or output (I/O) devices 506 (or peripherals) that are communicatively coupled via a local interface 508. The software in memory 504 can include one or more separate programs, each of which comprises an ordered listing of executable instructions for implementing logical functions. In the example of FIG. 5, the software in the memory 504 includes an operating system (O/S) 510, a text editor 520 and a call tree code view system 530.

When call tree code system 530 is implemented in software, it should be noted that the call tree code system can be stored on any computer-readable medium for use by or in connection with a computer-related system or method. In the context of this document, a computer-readable medium is an electronic, magnetic, optical, or other physical device or means that can contain or store a computer program for use by or in connection with a computer-related system or method. Call tree code view system 530 can be embodied in a computer-readable medium for use by or in connection with an instruction execution system, apparatus, or device, such as a computer-based system, processor-containing system, or other system that can fetch the instructions from the instruction execution system, apparatus, or device and execute the instructions.

In the context of this document, a “computer-readable medium” can be any means that can store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

Functionality of an embodiment of a call tree code view system will now be described with respect to the flowchart of FIG. 6. In FIG. 6, or any of the other accompanying flowcharts, it should be noted that the function associated with the various functional blocks may occur out of the order in which they are depicted in some embodiments.

As shown in FIG. 6, the functionality (or method) may be construed as beginning at block 610, where a procedure is identified within code. In block 620, a visual indicator corresponding to procedure content being associated with the procedure is provided. Then, in block 630, the procedure content is displayed in association with the procedure in response to the operator actuating the visual indicator.

Referring back briefly to the information displayed in FIG. 4, a visual indicator associated with the “callAFunction” procedure is depicted within the procedure content of the “myFunction” procedure. Upon actuation by the operator, the specific procedure content of the “callAFunction” procedure is displayed to the operator. In this embodiment, the “callAFunction” procedure content is depicted within spaced lines. Note that lines 412, 414 used to bound the “callAFunction” procedure content are displayed between lines 404 and 406, which bound the “myFunction” procedure content.

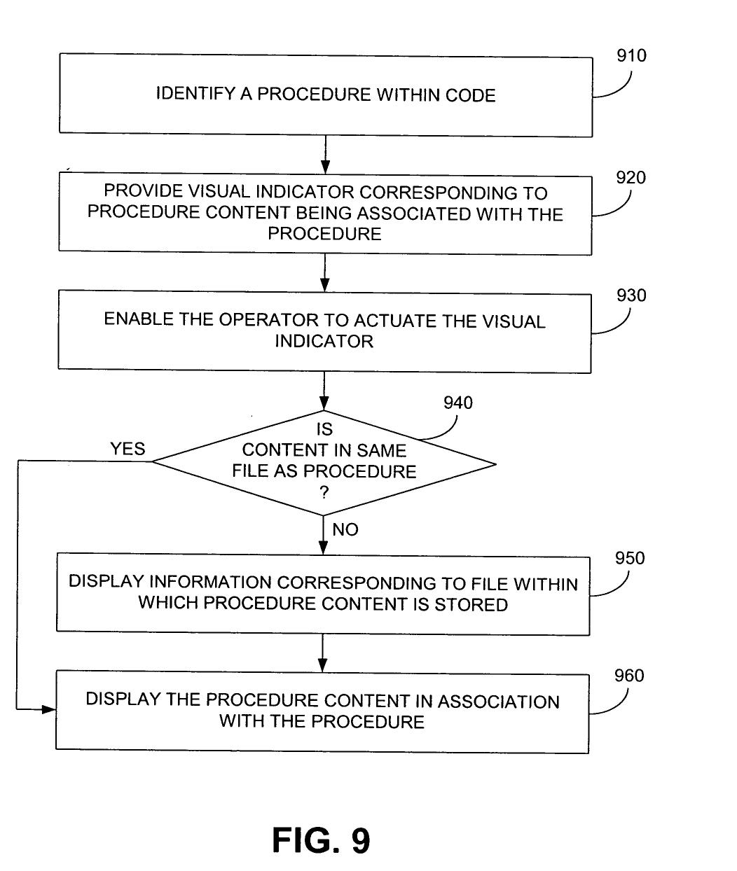

In some embodiments, additional information regarding the particular implementation of a procedure can be displayed to a user. By way of example, the embodiment depicted in FIG. 8 displays the location of the file in which the procedure content of a particular procedure is stored. Thus, in this example, the procedure content of“myFunction” is stored in the file “OtherFilejava.” The functionality associated with an embodiment of a call tree code view system that provides a display such as that depicted in FIG. 8 is presented in the flowchart of FIG. 9.

As shown in FIG. 9, the functionality (or method) may be construed as beginning at block 910, where a procedure is identified. In block 920, a visual indicator is provided that corresponds to procedure content being associated with the procedure. In block 930, an operator is enabled to actuate the visual indicator. By way of example, the operator may click on the underlined name of the procedure. In block 940, a determination is made as to whether the procedure content associated with the procedure is located in the same file as the procedure. If it is determined that the content is located in a different file, the process proceeds to block 950. In block 950, information corresponding to the file in which the procedure content is stored is displayed to the operator. In block 960, the procedure content is displayed to the operator in association with the procedure. Note that the process also proceeds to block 960 if it was determined in block 940 that the content is associated in the same file as the procedure.

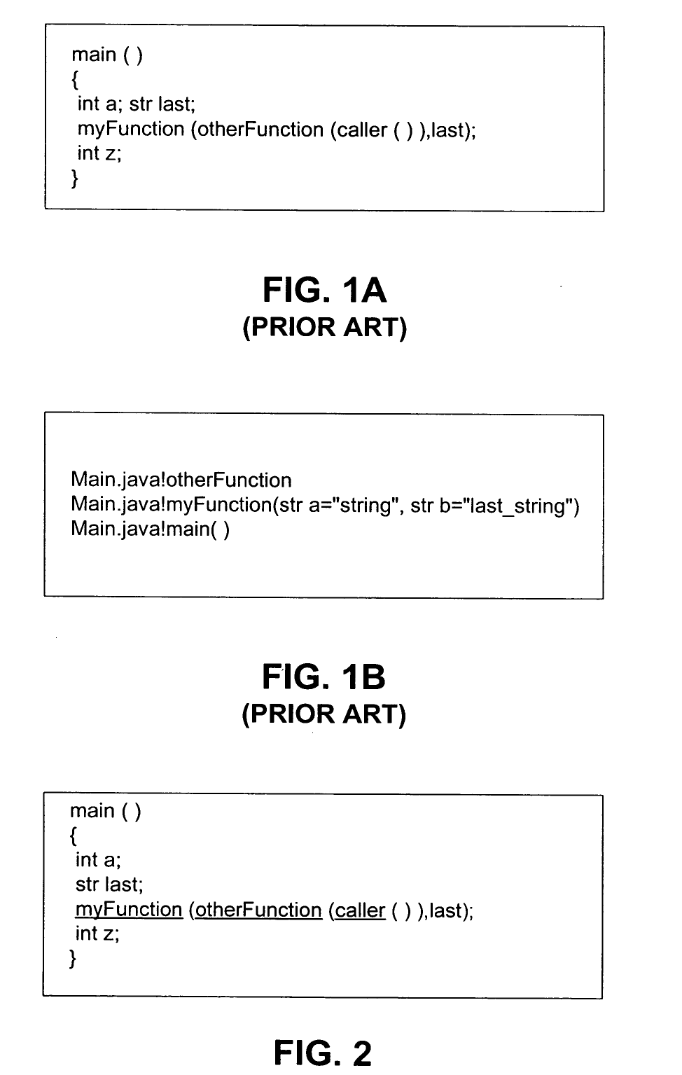

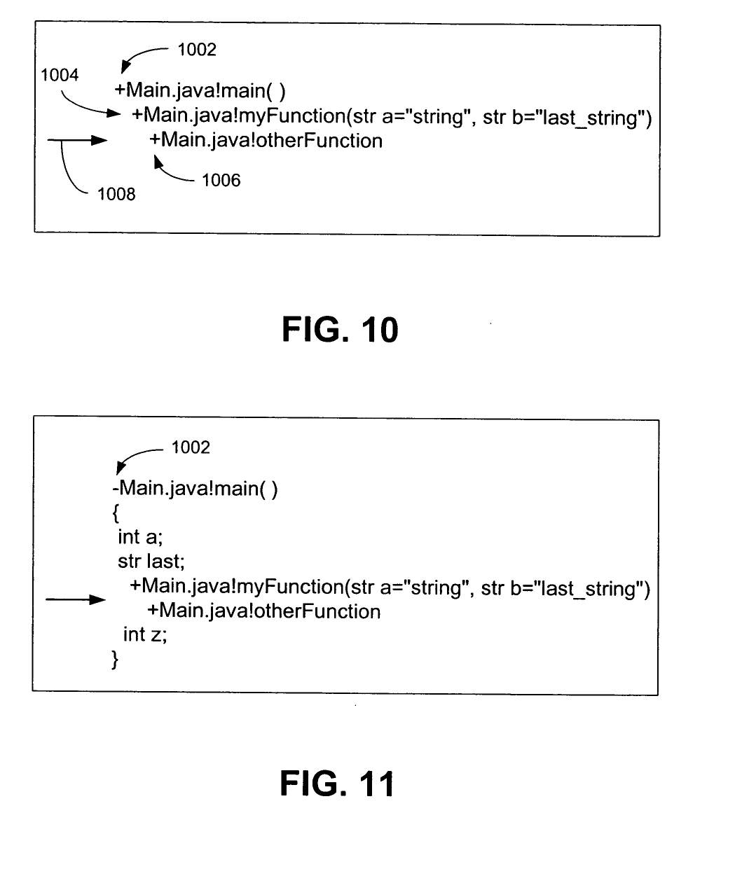

FIG. 10 is a schematic diagram depicting a representative display provided by another embodiment of a call tree code view system. As shown in FIG. 10, the lines of code previously presented with respect to FIG. 1B are now provided in a format that readily identifies that a particular procedure is associated with procedure content, with that procedure content being readily accessible by the operator. In particular, each procedure includes an indictor, which identifies to the operator whether that procedure is associated with procedure content. In the example provided in FIG. 10, each of the visual indictors 1002, 1004 and 1006 is a plus sign (“+”) which indicates that procedure content is available for viewing. Note that arrow 1008 indicates the current line of execution.

In response to actuating the indicator, such as by clicking on the indicator, the procedure content associated with that procedure is displayed, as shown in FIG. 11. The indicator also is changed to show that the procedure content has been accessed. In this case, the indicator 1002 has changed from a plus sign (“+”) to a minus sign (“−”). Note that in this embodiment, the procedure contact associated with a given procedure is indicated with respect to that procedure when displayed.

It should be emphasized that many variations and modifications may be made to the above-described embodiments. All such modifications and variations are intended to be included herein within the scope of this disclosure and protected by the following claims.

1. A method for viewing code comprising the steps of:
providing a procedure;
providing a visual indicator corresponding to procedure content being associated with the procedure; and
displaying the procedure content in association with the procedure in response to an operator actuating the visual indicator.

2. The method of claim 1, wherein the visual indicator is a name of the procedure displayed in an underlined format.

3. The method of claim 1, wherein the operator actuates the visual indicator by clicking the visual indicator.

4. The method of claim 1, wherein, in displaying the procedure content in association with the procedure, the procedure content is displayed between a pair of lines.

5. The method of claim 4, wherein the procedure content is indented with respect to the procedure.

6. The method of claim 5, wherein the procedure content includes an additional procedure that has additional procedure content associated therewith, the additional procedure including an additional visual indicator.

7. The method of claim 1, wherein the procedure is a function.

8. The method of claim 1, wherein the procedure is stored in a first file and the procedure content is stored in a second file; and
further comprising:
displaying information corresponding to the second file to the operator.

9. The method of claim 8, wherein, in displaying the procedure content in association with the procedure, the procedure content is displayed between a pair of lines, the information corresponding to the second file being displayed adjacent to at least one of the lines.

10. The method of claim 1, wherein the visual indicator comprises a plus sign when the procedure content is not being displayed, and comprises a minus sign when the procedure content is being displayed.

11. A computer-readable medium having a computer program stored thereon, the computer program being executable to perform the method steps of:
receiving information corresponding to a procedure;
displaying a visual indicator corresponding to procedure content being associated with the procedure;
receiving information corresponding to an operator actuating the visual indicator; and
displaying the procedure content in association with the procedure in response to the operator actuating the visual indicator.

12. The computer-readable medium of claim 11, wherein the visual indicator is a name of the procedure displayed in an underlined format.

13. The computer-readable medium of claim 11, wherein, in displaying the procedure content in association with the procedure, the procedure content is displayed between a pair of lines.

14. The computer-readable medium of claim 11, wherein, in displaying the procedure content in association with the procedure, the procedure content is indented with respect to the procedure.

15. The computer-readable medium of claim 11, wherein:
the procedure is stored in a first file and the procedure content is stored in a second file; and
further comprising the method step of:
displaying information corresponding to the second file to the operator.

16. The computer-readable medium of claim 15, wherein, in displaying the procedure content in association with the procedure, the procedure content is displayed between a pair of lines, the information corresponding to the second file being displayed adjacent to at least one of the lines.

17. The computer-readable medium of claim 11, wherein the visual indicator comprises a plus sign when the procedure content is not being displayed, and comprises a minus sign when the procedure content is being displayed.

18. A system for viewing code comprising:
a call tree code view system operative to:
receive information corresponding to a procedure;
display a visual indicator corresponding to procedure content being associated with the procedure;
receive information corresponding to an operator actuating the visual indicator; and
display the procedure content in association with the procedure in response to the operator actuating the visual indicator.

19. The system of claim 18, further comprising:
a text editor application operative to enable a operator to edit code, the text editor comprising the call tree code view system.

20. The system of claim 18, further comprising:
a display device communicating with the call tree code view system, the display device being operative to receive information from the call tree code view system such that the procedure content is displayed to the operator in association with the procedure in response to the operator actuating the visual indicator.
